(19) United States
(12) Patent Application Publication
(10) Pub. No.: US 2011/0158331 A1
(43) Pub. Date: Jun. 30, 2011

(54) Emulating Increased Sample Frequency in a Wireless Sensor Node and/or a Wireless Sensor Network

(75) Inventors: Robert Kavaler, Kensington, CA (US); Akhila Raman, Berkeley, CA (US)

(73) Assignee: SENSYS NETWORKS. INC, Berkeley, CA (US)

(21) Appl. No.: 12/982,836

(22) Filed: Dec. 30, 2010

Related U.S. Application Data
(60) Provisional application No. 61/291,595, filed on Dec. 31, 2009.
(60) Provisional application No. 61/428,820, filed on Dec. 30, 2010.

(51) Int. Cl. H04L 27/00; G01K 1/00; G06F 9/445

(52) U.S. Cl. 375/259; 702/130; 702/176; 717/176

(57) ABSTRACT

Apparatus and processors for wireless sensor nodes are disclosed emulating increasing the sampling frequency of the sensors of the wireless sensor nodes. Apparatus and processors are disclosed using the improved sensor readings to generate vehicle parameters for vehicles passing near one of the nodes, movement estimates and traffic ticket messages, any of which may be sent to other systems. Some of these embodiments may be used with and/or in the wireless sensor nodes and/or with or in an access point for the wireless sensor nodes. Installation devices and/or servers and/or computer readable memories are disclosed for delivering the operational configurations and/or installation packages and/or program systems to the various embodiments of the apparatus and/or processors.

### CROSS REFERENCE TO RELATED APPLICATIONS

This application claims priority to the following: U.S. Provisional Patent Application Ser. No. 61/291,595, filed Dec. 31, 2009, and U.S. Provisional Patent Application Ser. No. 61/428,820, filed Dec. 30, 2010, which are incorporated herein by reference in their entirety.

### TECHNICAL FIELD

This invention relates to signal estimation for wireless sensor nodes that operate sensors with batteries. The invention emulates increasing the sampling frequency with little or no additional drain on the batteries. The invention also relates to using these improved sensor readings to generate vehicle parameters such as length, number of axles, and axle positions, movement estimates such as velocity and acceleration, and traffic ticket messages based upon the movement estimates and/or the vehicle parameters. Any combination of these parameters, estimates and/or messages may be sent to other systems.

### BACKGROUND OF THE INVENTION

A wireless sensor node operates by using power only when operating its sensors, a processor, its wireless transmitter and/or its receiver. The more often it operates its sensors, the shorter its battery life expectancy. While some wireless sensor nodes may be equipped with solar cells or some other renewable energy source, such sources tend to only be available for part of the time, such as sunny days. Methods and apparatus are needed to emulate increasing the sampling frequency without additionally operating the sensor, thereby conserving battery power.

### SUMMARY OF INVENTION

Two sets of embodiments are disclosed. The first set includes a first apparatus and possibly a second apparatus. The first apparatus is configured for use with a wireless sensor node and includes a processor. The processor may be configured to receive a sensor reading, N times per time unit, generated by a sensor, where N may be at least two. The processor generates an improved estimate, and/or an improved time stamp. The improved estimate and/or time stamp emulates the sensor readings received at an increased sampling frequency. The increased sampling frequency may be at least twice the N times per time unit.

The wireless sensor node may include the apparatus and a battery configured to provide electrical power to the apparatus. The battery may be configured to receive power from at least one photovoltaic cell. An integrated circuit and/or a circuit board may include the apparatus.

The improved estimate may include at least part of an improved sensor reading and/or at least one improved reading characteristic. The improved reading characteristic may include an edge estimate and/or an extrema estimate and/or a frequency domain estimate. The edge estimate may estimate a rising edge, a falling edge, a leading edge and/or a trailing edge. The extrema estimate may estimate a local minimum or a local maximum of at least part of the improved sensor readings. The frequency domain estimate may include at least one frequency band amplitude.

The second apparatus may be configured for use with the wireless sensor nodes implementing the first apparatus. The second apparatus may receive an improved sensor report from each of at least two of the wireless sensor nodes to create a table of the improved reading characteristics.

The second apparatus may include a second processor configured to generate a vehicle parameter, a movement estimate and/or a traffic ticket message about a vehicle passing near one or more of the wireless sensor nodes. The vehicle parameters may include the estimated length of the vehicle, an axle count and/or at least one axle position. The movement estimate of the vehicle may include a velocity estimate and/or an acceleration estimate. The movement estimate may further include a confidence estimate of the velocity and/or acceleration estimates.

The movement estimate may be based upon a first correlation of the extrema estimates from the wireless sensor nodes and/or upon a second correlation of the edge estimates. For example, the first correlation of the extrema estimates may match local minima and local maxima from the tables of improved reading characteristics to create correlated extrema. The movement estimate may be based upon a difference in the time stamps of the correlated extrema.

The second apparatus may further include a removable interface coupling coupled to the second processor. The second processor may be further configured to use the removable interface coupling to receive the improved sensor report and to send the vehicle parameter, the movement estimate, and/or the traffic ticket message, to the access point and possibly to other systems. The removable interface coupling may be compatible with any version of a USB protocol, a Firewire protocol, and/or a LAN protocol.

A second circuit board and/or a second integrated circuit may include the second processor. An access point configured to wirelessly communicate with the wireless sensor nodes may include the second processor.

A second set of embodiments includes a third apparatus with a third processor. The third processor may be configured to respond to sensor reports received from wireless sensor nodes based upon sensor readings. The sensor readings are generated by sensors N times per time unit in each of the wireless sensor nodes. The third processor may respond to receiving the sensor reports by generating an improved estimate and/or an improved time stamp. The improved estimate and/or time stamp emulates sensor readings generated at an increased sampling frequency. The increased sampling frequency may be at least twice the N times per time unit.

The third processor may be further configured to generate at least part of the vehicle parameter, the movement estimate of the vehicle, and the traffic ticket message as previously discussed. The third processor may be configured to communicate with an access point similar to the second processor. A third integrated circuit, a third circuit board, and/or the access point, may include the third processor.

### BRIEF DESCRIPTION OF THE DRAWINGS

FIG. 1 shows an example of the first set of embodiments implementing a wireless sensor network using embodiments of two apparatus. The first apparatus is embodied in at least two of the wireless sensor nodes include a processor that generates an improved estimate and/or an improved time stamp that emulates at least doubling the sensor sampling rate. The second apparatus includes a second processor, that may use the improved sensor estimates and/or improved time stamps to generate any combination of a parameter of a vehicle, a movement estimate of the vehicle, and/or a traffic ticket message, any of which may be sent to a traffic speed enforcement system. In this example, the access point includes the second apparatus and its second processor.

FIG. 2A shows the sensor readings may be distributed evenly throughout the time unit.

FIG. 2B shows the sensor readings may be distributed unevenly throughout the time unit.

FIG. 3 shows some details of the sensors that may be used in the wireless sensor nodes.

FIG. 4 shows the improved estimate may include an improved sensor reading and/or an improved reading characteristic, which may include edge estimates, and/or extrema estimates, and/or frequency domain estimates.

FIGS. 5A and 5B show some details of the signal processing that the processor may be configured to perform in terms of filtering the sensor readings to create at least part of the improved sensor readings and/or the improved reading characteristics.

FIGS. 6A to 6C show some details of the wireless sensor network of FIG. 1 composed of wireless sensor nodes that use the sensor that includes the magnetic sensor.

FIG. 7 shows the processor may be further configured to create at least one reading characteristic based upon the improved readings and/or the improved time stamps and that the wireless sensor node may include a transmitter and/or a receiver possibly employing various carrier bands and/or various communication schemes and/or compliant with various communications protocols.

FIG. 8 shows the processor may implement at least one of several means for performing various disclosed operations of the first apparatus.

FIG. 9 shows the processor and/or at least one of its means may include at least one instance of a finite state machine, a computer and/or an accessible memory including a program system configured to instruct the computer in accord with this disclosure. The Figure also shows an installation device, a server and/or a computer readable memory that may be configured to deliver an installation package and/or the program system and/or a finite state machine configuration.

FIGS. 10A to 10C show some details of the program system and/or operating the finite state machine as at least part of, at least one of, the shown steps of operating the apparatus.

FIG. 11 shows the improved sensor reports of the two sensor nodes of FIG. 1 and some examples of the information these improved sensor reports may deliver to the second apparatus and the second processor.

FIG. 12 shows the access point may not contain the second apparatus as shown in FIG. 1. But the second apparatus may be included in a second circuit board and/or a second integrated circuit similarly to FIG. 1. Some details of the second processor, the vehicle parameter and the movement estimate are also shown.

FIG. 13 shows the second apparatus may further include a removable interface coupling to the coupled to the second processor. The second processor may be further configured to use the removable interface to receive the improved sensor report and to send the movement estimate and/or the traffic ticket message, either through the access point as shown in FIG. 1 or directly to other systems such as the traffic enforcement system as shown in this Figure. The second processor is also shown including at least one of several means for operating the second apparatus.

FIG. 14 is similar to FIG. 9 and shows the second processor and/or means of FIG. 13 may include at least one implementation of at least one of a second finite state machine, a second computer and a second accessible memory including a second program system configured to instruct the second computer. A second installation device, a second server and/or a second computer readable memory are also shown.

FIG. 15 shows a flow chart of the second program system includes, and/or the operations the second finite state machine is configured to support, as at least part of, at least one of, the shown steps of operating the second apparatus.

FIG. 16 shows a second set of embodiments as a third apparatus including a third processor that may be included in a third integrated circuit and/or a third circuit board and/or an access point configured to communicate with wireless sensor nodes that do not emulate increasing the sampling frequency of their sensors. The third apparatus and/or the third processor provide the wireless sensor network an emulation of increased sampling frequency.

FIG. 17 shows another embodiment of the third apparatus that is not included in the access point but may be included in a third circuit board and/or a third integrated circuit. Some details of the third processor are shown indicating means for filtering sensor reading estimates

FIG. 18 shows the third apparatus including a removable interface coupling and the third processor and/or at least one of its means including at least one instance of a third finite state machine and/or a third computer and/or a third accessible memory possibly containing a third program system and/or a third installation package. This set of embodiments may include the second installation device and/or the second server and/or a second computer readable memory as previously discussed with regards the second apparatus.

FIGS. 19A and 19B show some details of the third program system and/or the operations of the third finite state machine which are similar to a merger of the operations of the first processor and second processor with the main difference being that the third processor starts with sensor reading estimates and the first processor starts with the sensor readings.

### DETAILED DESCRIPTION OF DRAWINGS

This invention relates to signal estimation for wireless sensor nodes that operate sensors with batteries. The invention emulates increasing the sampling frequency with little or no additional drain on the batteries. The invention also relates to using these improved sensor readings to generate vehicle parameters such as length, number of axles, and axle positions, movement estimates such as velocity and acceleration, and traffic ticket messages based upon the movement estimates and/or the vehicle parameters. Any combination of these parameters, estimates and/or messages may be sent to other systems.

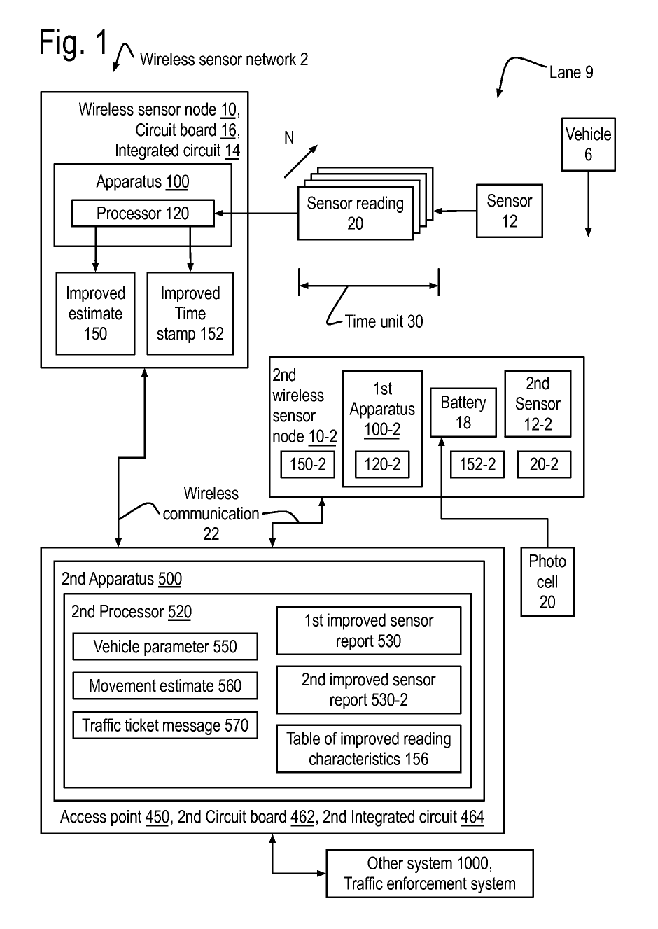

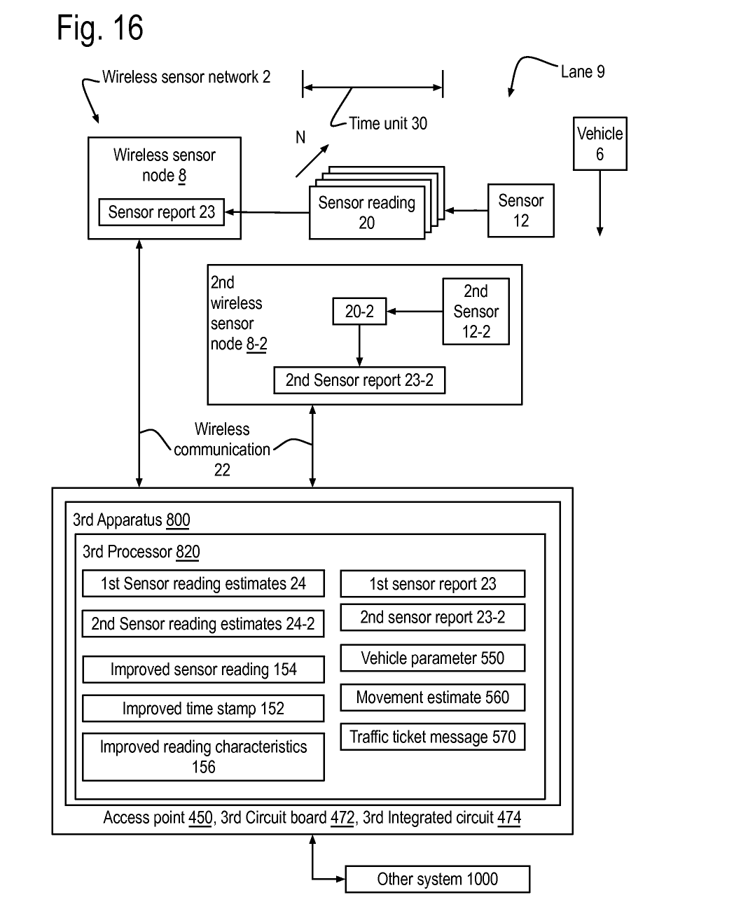

Two sets of embodiments are disclosed. The first set includes a first apparatus 100 and possibly a second apparatus 500 as shown beginning in FIG. 1. Disclosure of a second set of embodiments that may include a third apparatus 800 with a third processor 820 begins in FIG. 16.

FIG. 1 shows an example of a wireless sensor network 2 using embodiments of two apparatus 100 and 500.

The first apparatus 100 is configured for use with a wireless sensor node such as 20 and 20-2 and includes a processor 120. The processor 120 may be configured to receive a sensor reading 20, N times per time unit 30, generated by a sensor 12, where N may be at least two. The processor generates an improved estimate 150, and/or an improved time stamp 152. The improved estimate 150 and/or the improved time stamp 152 emulates the sensor readings 20 received at an increased sampling frequency. The increased sampling frequency may be at least twice the N times per time unit 30.

The second apparatus 500 may include a second processor 520, that may use the improved sensor estimates 150 and/or improved time stamps 152 to generate any combination of a parameter 550 of a vehicle 6, referred to herein as a vehicle parameter 550, a movement estimate 560 of the vehicle 6, and/or a traffic ticket message 570, any of which may be sent to other systems such as a traffic speed enforcement system 1000 across any combination of wireless and wireline physical transports, such as Local Area Networks (LAN) and/or Wireless LANs (WLAN).

Some details regarding the first apparatus 100 will be discussed first, followed by a discussion of some details regarding the second apparatus 500.

The wireless sensor network 2 may include at least one of the wireless sensor nodes 10 and 10-2 wirelessly communicating with at least one access point 450.
The first wireless sensor node 10 may include the first instance of the first apparatus 100 that further includes the first instance of the processor 120. The first processor 120 may be configured to respond to the sensor readings 20 generated by the sensor 12, N times per time unit 30 to create at least one improved estimate 150 and/or at least one improved time stamp 152.
The second wireless sensor node 10-2 may include the second instance of the first apparatus 100-2 that further includes the second instance of the processor 120-2. The processor 120-2 may be configured to respond to the sensor readings 20-2 generated by the sensor 12-2 N times per time unit 30 to create at least one improved estimate 150-2 and/or at least one improved time stamp 152-2.

N may be at least two and may be larger, for instance it may be 128 for the time unit 30 of one second in some embodiments. In other embodiments, the N may be a different number, such as 1024. The time unit may include multiples of a second and/or fractions of a second. The time unit 30 may also be in terms of minutes, hours and/or days in certain embodiments.

Various configurations of the wireless sensor node 20 and/or 20-2 may be embodied. The first wireless sensor 12 may communicate with the wireless sensor node 10, but may not be included in the wireless sensor node 10, whereas the second sensor 12-2 may be included in the second wireless sensor node 10-2.

The second wireless sensor node 20-2 is shown including a battery 18 that may be used to provide power for the apparatus 100-2 and/or the processor 120-2. The battery 18 may be configured to receive power from one or more photo-voltaic cells 20.

At least one of the wireless sensor nodes, for example the second wireless sensor node 10-2, may include the apparatus 100-2 and a battery 18 configured to provide electrical power to the apparatus 100-2. The battery 18 may be configured to receive power from at least one photovoltaic cell 20.

In certain implementations of the wireless sensor network 2, the wireless sensor nodes 10 and 10-2 may be embedded in the pavement Pv of a lane 9 of a roadway, as further shown in FIGS. 6B and 6C hereafter.

FIG. 1 further shows the second apparatus 500 may configured to use wireless communication 22 with the wireless sensor nodes 10 and 10-2 to use their improved estimates 150 and/or their improved time stamps 152. The second apparatus 500 includes a second processor 520 may use the improved sensor estimates 150 and/or the improved time stamps 152 to generate any combination of a parameter of a vehicle 6, referred to herein as a vehicle parameter 550, a movement estimate 560 of the vehicle 6, and/or a traffic ticket message 570, any of which may be sent to other systems such as a traffic speed enforcement system 1000.

An integrated circuit 14 and/or a circuit board 16 may include the apparatus 100. And a second circuit board 462 and/or a second integrated circuit 464 may include the second apparatus 500. Note that in some embodiments, a single integrated circuit 14 may be configured to perform as the first apparatus 100 and/or as the second apparatus 500.

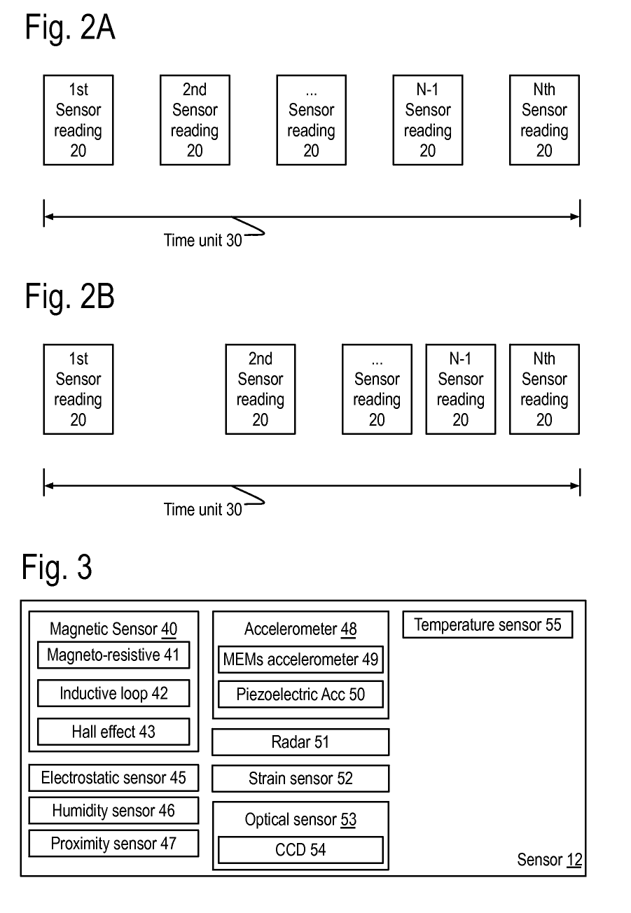

FIG. 2A shows the sensor readings 20 may be distributed evenly throughout the time unit 30. And FIG. 2B shows the sensor readings 20 may be distributed unevenly throughout the time unit 30.

FIG. 3 shows that at least one instance the sensor 12 may include at least one of a magnetic sensor 40, an electrostatic sensor 45, a humidity sensor 46, a proximity sensor 47, an accelerometer 48, a radar 51, a strain sensor 52, an optical sensor 53 and/or a temperature sensor 55. The magnetic sensor 40 may include at least one of a magneto-resistive sensor 41, an inductive loop 42, and/or a Hall sensor 43. The accelerometer 48 may include a MEMS accelerometer 49 and/or a piezoelectric accelerometer 50. The optical sensor 53 may include a Charge Coupled Device (CCD) 54.

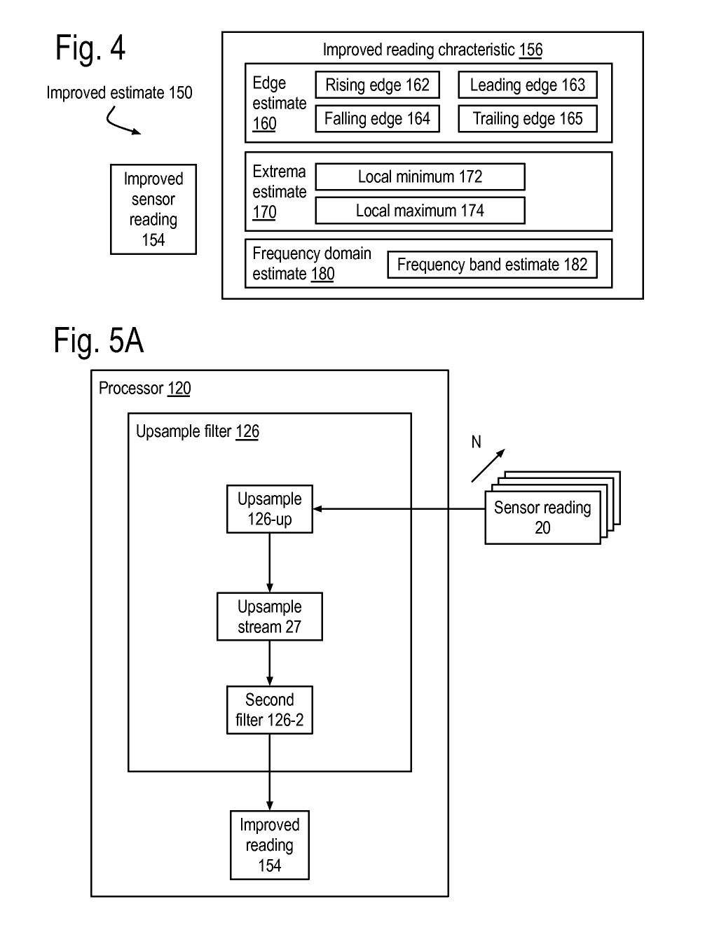

FIG. 4 shows the improved estimate 150 may include an improved sensor reading 154 and/or an improved reading characteristic 156. The improved reading characteristic 156 may include an edge estimate 160, an extrema estimate 170, and/or a frequency domain estimate 180. The edge estimate 160 may indicate a rising edge 162 or a falling edge 164. In other embodiments, the extrema estimate 160 may indicate a leading edge 163 and/or a trailing edge 165. The extrema estimate 170 may indicate a local minimum 172 or a local maximum estimate 174. The frequency domain estimate 180 may include at least one frequency band estimate 182.

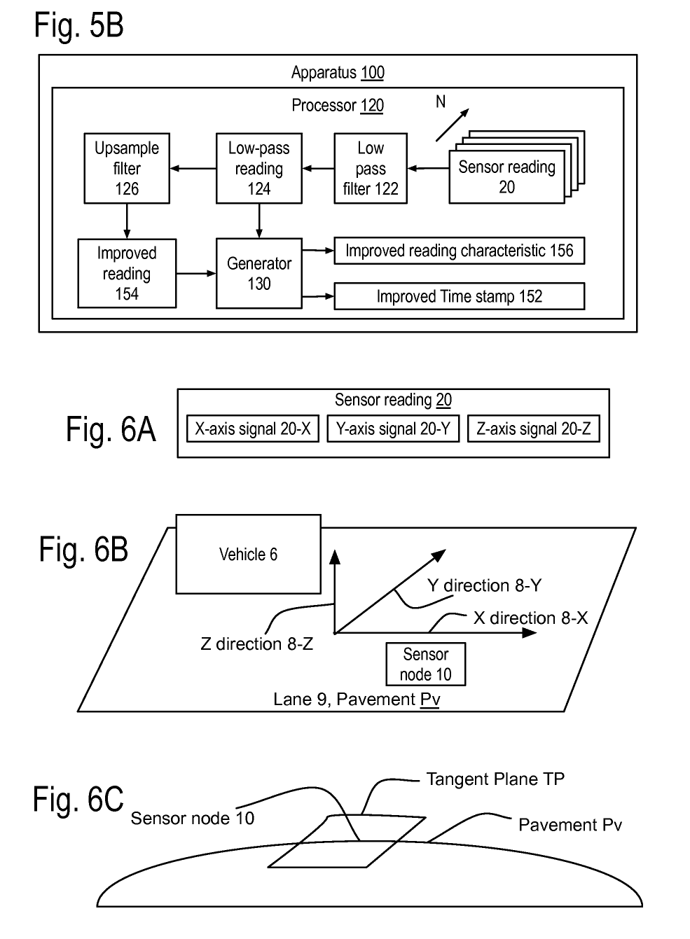

FIGS. 5A and 5B show some details of the signal processing that the processor 120 may be configured to perform in terms of filtering the sensor readings 20.

FIG. 5A shows the processor 120 of FIG. 1 may be further configured to upsample filter 126 the sensor readings 20 to generate the improved sensor reading 154. As used herein, an upsample filter 126 generates more samples output than sample inputs 20. In some contexts, the upsample filter may be decomposed into upsampling 126-up and a second filtering 126-2 at least part of the upsampled data 27 stream to emulate increasing the sampling frequency without having to operate the sensor 12 more often.

As used herein, the upsampled filter 126 may perform an up-sampling 126-up of an input stream 20 to create an up-sampled data stream 27 used by a second filter 126-2 to generate the output of the upsampled filter 126.
Up-sampling 126-up that may be implemented in a variety of ways.
   For example, each input sample may be replicated one or more times.
   Another example, each input sample may have a fixed value, such as zero inserted between it and the next input sample.
   Another example, the input sample may be inserted between a running and/or windowed average of the input stream.
The second filter 126-2 may be composed of two or more subband filters whose outputs are sub-sampled so that the output rate of the second filter 126-2 may be the same the up-sampled input stream rate 27, which may then be twice or more times the input stream 20 rate of the upsampled filter 126.

FIG. 5B shows a refinement of FIG. 5A, the processor 120 may include a low pass filter 122 receiving at least part of the sensor readings 20 to generate a low pass reading 124. At least some of the low pass readings 124 may be used by the upsample filter to at least partly, further generate the improved sensor reading 154. The low pass reading 124 and/or the improved sensor reading 154 may be used to generate 130 the improved reading characteristic 156 and/or the improved time stamp 152.

Consider an example of the wireless sensor network 2 of FIG. 1 composed of wireless sensor nodes 10 that use a sensor 12 that includes a magnetic sensor 40 to be shown and discussed in FIGS. 6A to 6C. The magnetic sensor 40 may further include at least one magneto-resistive sensor 41.

FIG. 6A shows an example of the sensor reading 20 generated by a magnetic sensor 40, in particular, a magneto-resistive sensor 41, that may include at least two of a magnitude in an X axis direction 8-X, referred to as the X magnitude 20-X, a magnitude in a Y axis direction 8-Y, referred to as the Y magnitude 20-Y, and a magnitude in a Z axis direction 8-Z, referred to as the Z magnitude 20-Z.

FIG. 6B shows an example of the wireless sensor node 10 embedded in the pavement Pv of a lane 9 that is essentially flat showing the X axis direction 8-X, the Y axis direction 8-Y, and the Z axis direction 8-Z, by which the movement of the vehicle 6 may be estimated.

FIG. 6C shows an example implementation where the pavement Pv is not flat and the local reference plane for the axes of FIG. 6B becomes the tangent plane (TP) of the pavement in the neighborhood of the wireless sensor node 10.

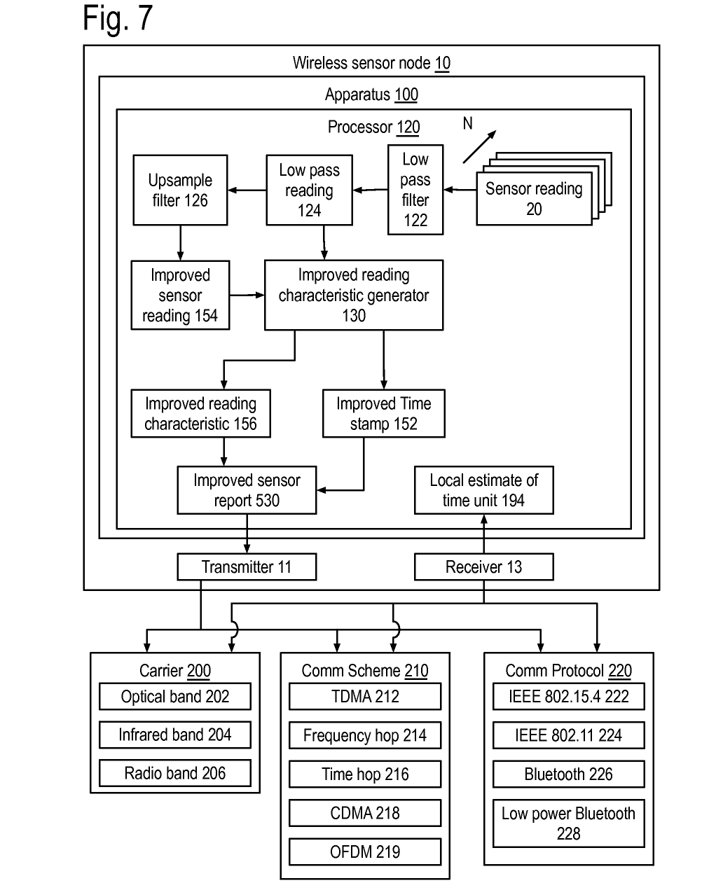

FIG. 7 shows the processor 120 may be further configured to create at least one of the improved reading characteristics 156 based upon the improved sensor readings 154 and/or the improved time stamps 152. The processor 120 may include an improved reading characteristic generator 130 the may receive at least some of the improved sensor readings 154 and/or at least some of the low pass readings 124 to create at least some of the improved reading characteristics 156 and/or the improved time stamps 152. An improved sensor report 530 may be constructed based upon the improved estimates 150, possibly based upon the improved reading characteristics 156 and/or based upon the improved time stamps 152.

For example, the improved reading characteristic generator 130 may only produce improved edge estimates 160. Whereas in other embodiments the improved reading characteristic generator 190 may only produce improved extrema estimates 170. And in yet other embodiments, improved reading characteristic generator 130 may only produce improved frequency domain estimates 180.

As used herein, a low pass filter is a filter that is configured to pass with little or no resistance a low frequency signal component and to attenuate or resist a frequency component above a cut-off frequency. Some implementations of low pass filters are implemented in digital forms. One particular form of a digital implementation of the first filter 122 as a low pass filter may average the preceding K digital readings 20 to create the first-filtered reading 124, where a value of K is at least two and may be preferred to be at least four for N=128 samples in the time unit 30 of one second.

The apparatus 100 may be configured to use a transmitter 11 to transmit at least the improved sensor report and/or to use a receiver 13 to synchronize the wireless sensor node 10 to maintain a local estimate the time unit 194. The transmitter 11 and/or the receiver 13 may use various communication schemes and/or communication protocols.

The transmitter 11 and/or the receiver 13 may use a carrier 200 in an optical band 202 and/or an infrared band 204 and/or a radio band 206.

The transmitter 11 and/or the receiver 13 may use one or more communication schemes 210, for instance a Time Division Multiple Access (TDMA) scheme 212, a Frequency hopping scheme 214, a time hopping scheme 216, a code division multiple access (CDMA) scheme 218 and/or an Orthogonal Frequency Division Modulation (OFDM) scheme 219.

The transmitter 11 and/or the receiver 13 may be compatible with a version of a wireless communication protocol 220, such as an Institute for Electrical and Electronic Engineers (IEEE) 802.15.4 protocol 222, an IEEE 802.11 protocol 224, a Bluetooth protocol 226 and/or a Bluetooth low power protocol 228.

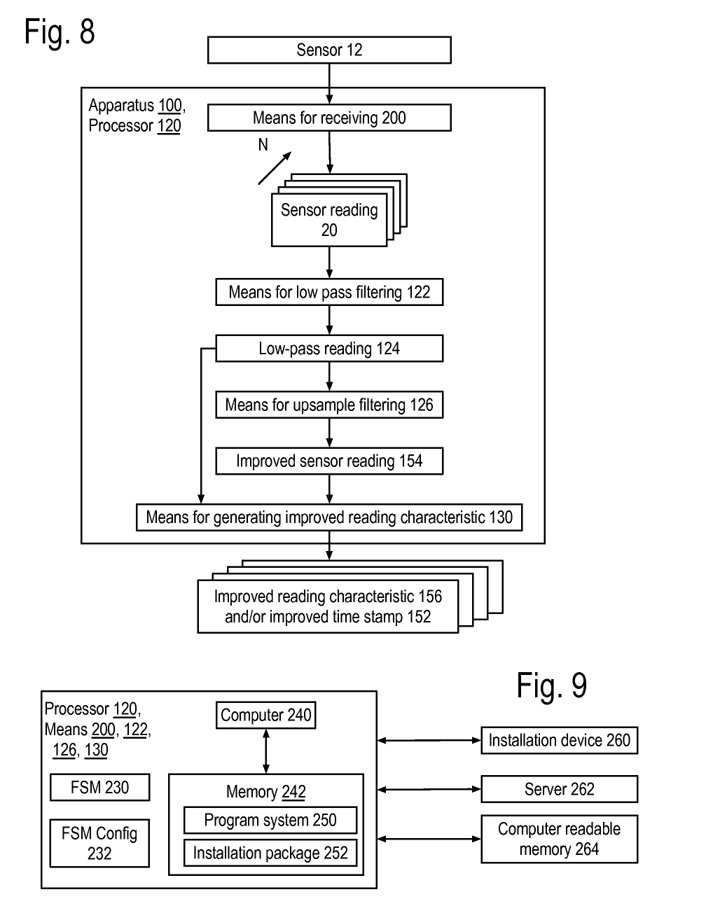

FIG. 8 shows the processor 120 may implement at least one of several means for performing various disclosed operations of the apparatus 100. By way of example, the sensor 12 may communicate with a means for receiving 200 to generate the sensor readings 20. A means for low pass filtering 122 may respond to the received sensor readings 20 to generate the low-pass reading 124. A means for upsample filtering 126 may respond to the low pass reading 124 to generate the improved sensor reading 154. A means for generating 130 may respond to the improved sensor reading 154 and possibly to the low pass reading 124 to generate at least one improved reading characteristic and/or at least one improved time stamp 152.

The processor 120 may employ a fuzzy engine and/or a genetic algorithm to at least partly implement generation of the improved time stamp 152 and/or the improved sensor reading 154 and/or the improved reading characteristic 156. While such implementations are within the scope of the claimed invention, it should be noted that such implementations typically use Finite State Machines and/or computers, which will now be shown.

FIG. 9 shows the processor 120 and/or at least one of the means 200, 122, 126, 130 may include at least one instance of a finite state machine 230, a computer 204 and/or an accessible memory 242 including a program system 250 configured to instruct the computer 240 in accord with this disclosure.

FIG. 9 also shows the apparatus disclosed and claimed to include an installation device 260 and/or a server 262 and/or a computer readable memory 264, any or all of which may be configured to deliver to the processor 120, the computer 240 and/or the memory 242 at least part of the program system 250 and/or the installation package 252.

As used herein, a FSM 230 may be configured to receive at least one input, maintain at least one state and generate at least one output in response to a value of at least one of the inputs and/or in response to the value of at least one of the states. The FSM configuration 232 may be used to configure the FSM 230 implemented by a programmable logic device, such as a Field Programmable Gate Array (FPGA) to at least partly implement the disclosed apparatus.

As used herein, the computer 240 may include at least one instruction processor and at least one data processor with at least one of the instruction processor instructed by at least one of the instruction processors in response to the program system 250, possibly through accesses of the memory 242 by the computer 240.

As used herein, the installation package 252 may be configured to instruct the computer 240 to install the program system 250 and/or may be configured to instruct the computer and/or the FSM 230 to install the FSM configuration 232.

As used herein, the memory 242 and/or the computer readable memory 264 may include at least one instance of a volatile and/or a non-volatile memory component. A volatile memory component tends to lose its memory contents without a regular supply of power, whereas a non-volatile memory component tends to retain its memory contents without needing such a regular supply of power.

The computer readable memory 264 and/or the server 262 and/or the installation device 260 may include various communications interfaces to deliver the program system 250, the installation package 252, and/or the FSM configuration 232: a Bluetooth interface, and/or a Wireless LAN (WLAN) interface, and/or some combination of these and possibly other interfaces.

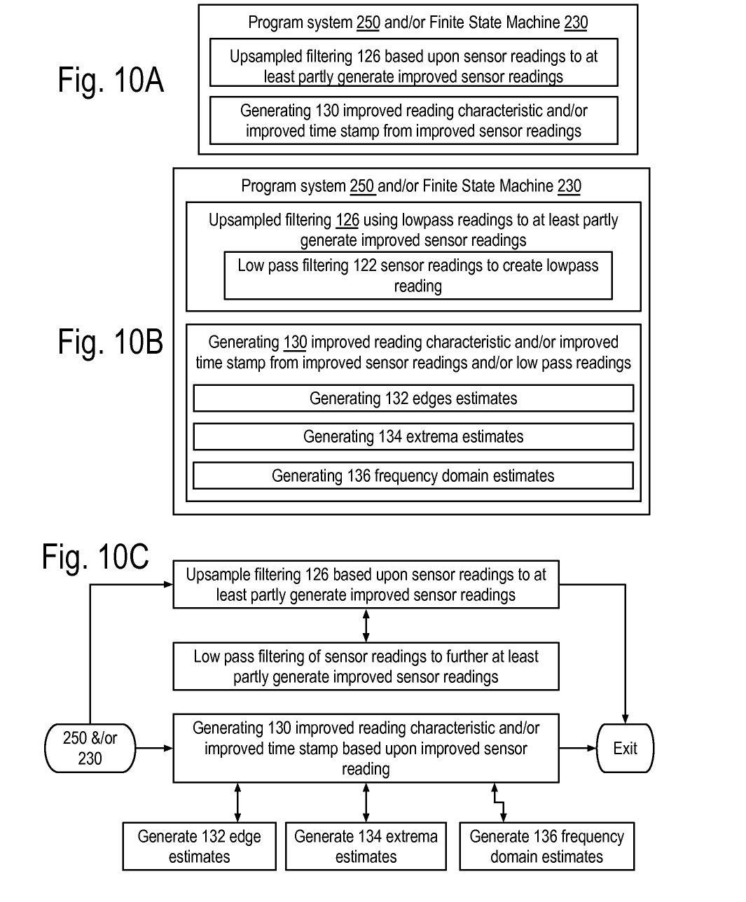

FIG. 10A shows some details of various embodiments of the program system 250 and/or the operation of the finite state machine 230 disclosing some details of the method of operating the various examples of the apparatus that may include the processor 100 of the previous Figures the first apparatus 100 as steps performed by its processor 120 and/or implemented by the finites state machine 230.

FIG. 10B shows a flowchart of the program system 250 implementing a first specific example of the processor 120 operating the apparatus 100 configured to receive the sensor readings 20 as shown in FIG. 5A:
The sensor readings 20 include magnetic signals mag(Z) 20-Z and mag(X) 20-X. The sensor readings 20 are filtered by the low pass filter 122 to generate the first-filtered readings 124 as first-mag(Z) and first-mag(X).
The first filtered readings 124 may be passed through generator 132 of edge estimates to generate the edge estimates 160.

The low pass filtered first-mag(Z) readings may be upsample filtered 126 to generate the improved sensor reading 154 as a second-mag(Z) readings.
As previously stated, upsampled filters 126 may be considered to include an up-sampling process and a second filter process. There are several variations of the upsampling which have already been discussed.
In some implementations, the second-filter 126-2 may employ nine taps. The tap values may be near the following vector in either a fixed point, floating point or logarithmic format: [−0.021359, −0.076633, −0.047043, 0.167437, 0.415379, 0.415379, 0.167437, −0.047043, −0.076633]. Alternatively, a different tap vector may be employed, which may or may not be near this example tap vector.
In other implementations, the second-filter 126-2 may employ a different number of taps, possibly greater than 9.

Generating 130 the improved reading characteristic 156 and/or the improved time stamp 152 based upon the improved sensor reading 154 may include any combination of the following:
The improved sensor readings 154 may be presented to a edge estimator 132 to generate one or more of the edge estimates 160.
The improved sensor readings 154, for instance the second-mag(Z) 154-Z readings, may be presented to a generator 134 of extrema estimates to generate the extrema estimates 170.
The improved sensor readings 154 may be presented to a band pass filter 136 to generate the frequency domain estimate 180.

FIG. 10C shows a flowchart view of the program system 250 and/or the operations of the finite state machine 230 as a different view of the material shown in FIGS. 10A and 10B.

There are some things to note about FIGS. 10A to 10C. In program optimization of the program system 250, particularly as such code is often triggered as a response to a real-time interrupt of the computer 240, the various process steps tend to be merged more in the spirit of FIGS. 10A and 10B. However, in terms of the design and analysis of the operations of the processor 120 and/or the apparatus 100, FIG. 10C is closer to the spirit of the research and initial specification for the development of the program system 250 and/or its implementation in terms of the means 130 for generating the improved estimate 150 and/or improved time stamp 152 of FIG. 8.

The improved estimates 150 and/or the improved time stamps 152 are then packaged into the improved sensor report 530 shown in FIG. 7 for transmission to the access point 450 of FIG. 1.

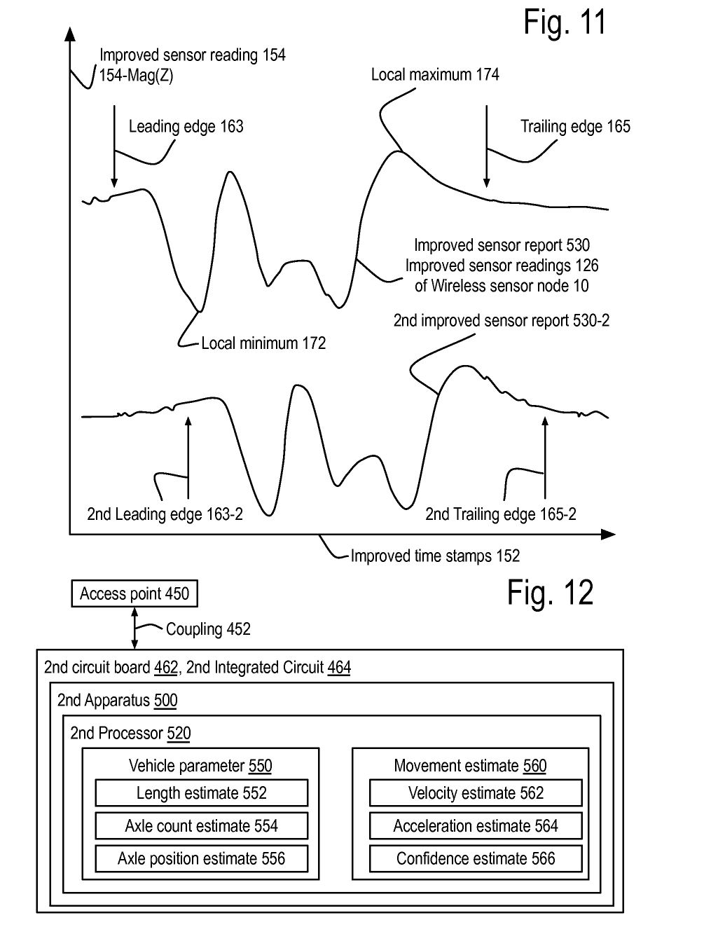

FIG. 11 shows a graph of an example of the improved sensor report 530 and the second improved sensor report 530-2 as received by the access point 450 and used by the second processor 520.
The first improved sensor report 530 may be received from wireless sensor node 20 and the second improved sensor report 530-2 may be received from the second wireless sensor node 20-2.
The horizontal axis represents improved time stamps 152 and the vertical axis, represents the improved sensor readings 154, in particular, the Z axis improved reading 154-mag(Z).
   Note that in some embodiments, the improved sensor report 530 may include the leading edge 163 and/or the trailing edge 165. Similarly, the second improved sensor report 530-2 may include a second leading edge 163-2 and/or a second trailing edge 165-2.
In some embodiments, the local minimum 172 and/or the local maximum 174 may be included in the improved sensor report 530 or derived from the improved sensor report 530.

Returning to the second apparatus 450 shown in FIG. 1. The second apparatus 500 may be configured to receive the improved sensor report 520 from each of at least two of the wireless sensor nodes such as 20 and 20-2 to create a table of the improved reading characteristics 156 for the wireless sensor node 20 in response to the presence of a vehicle 6 near the wireless sensor node 20.

The second apparatus 500 may include a second processor 520 configured to generate a vehicle parameter 550, a movement estimate 560 and/or a traffic ticket message 570 about a vehicle 6 passing near and/or between the wireless sensor node(s) 20 and 20-2 as shown in FIG. 1. A second circuit board 462 and/or a second integrated circuit 464 may include the second apparatus 500.

FIG. 12 shows an alternative example where the second apparatus 500 may not be included in the access point 450 but may be included in embodiments of the second circuit board 462 and/or the second integrated circuit 464. The second processor 520 may be configured to communicate via the coupling 452 with the access point 450 to receive the improved sensor reports 530 and 530-2.

The access point 450 may be coupled 452 to the second apparatus 500, possibly via at least one wireline and/or wireless communications coupling. The wireline communications coupling may be compatible with a version of, but not limited to, a LAN coupling, a Universal Serial Bus (USB) coupling and/or a Firewire IEEE 1394 coupling. The wireless communications coupling may employ any version of IEEE 802 communications protocols, for example, the IEEE 802.15.4 protocol 222 and/or the IEEE 802.11 protocol 224, and/or any version of Bluetooth protocol 226 and/or any version of the low power Bluetooth protocol 228.

The vehicle parameters 550 of the vehicle 6 may include the estimated length 552, an axle count 554 and/or at least one axle position estimate 556. The movement estimate 560 of the vehicle 6 may be based upon response to the tables of the reading characteristics 156 and may include a velocity estimate 562 and/or an acceleration estimate 564 and may further include a confidence estimate 566 of one or both of the velocity estimate and the acceleration estimate. The traffic ticket message 570 of FIG. 1 may based upon response to the movement estimate 560.

The second processor 520 may further generate a correlation of the extrema estimates of FIG. 10C from the two improved sensor reports 530 and 530-2 by matching local minima 172 and local maxima 174 between the tables to create at least two correlated extrema. Alternatively, the second processor 520 may generate a correlation between the edge estimates, in particular, between the leading edge 163 and the trailing edge 165. The movement estimate may be further based upon a difference in the improved time stamps 152 of the correlations.

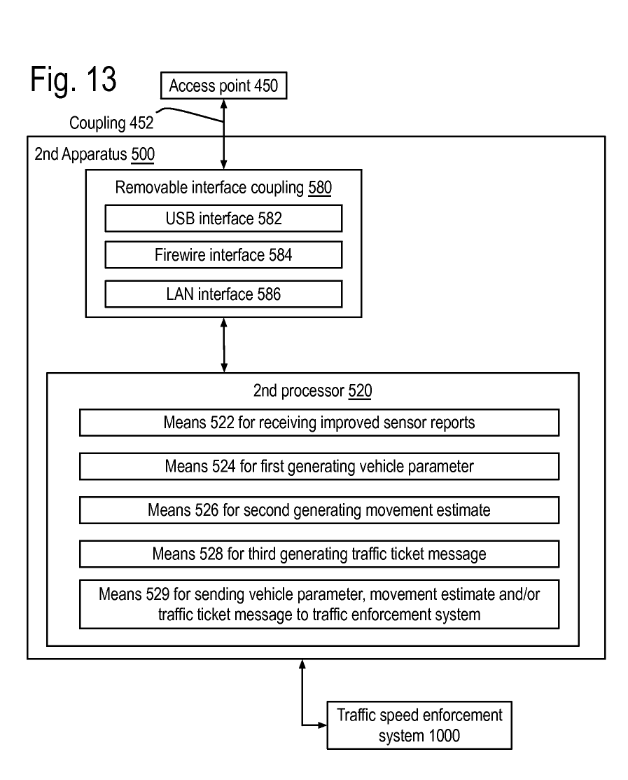

FIG. 13 shows the second apparatus 500 may further include a removable interface coupling 580 to the second processor 520. The second processor may be further configured to use the removable interface coupling 580 to receive the improved sensor reports such as 530 and 530-2. The second processor 520 may send the vehicle parameter 550 and/or the movement estimate 560 and/or the traffic ticket message 570 either through the removable interface coupling to the access point or directed to other systems such as the traffic speed enforcement system 1000. Examples of the removable interface coupling 580 include but are not limited to various forms of any of the following Universal Serial Bus 582, Firewire (IEEE 1394) 584, and LAN interfaces 586 such as interfaces to Ethernet and Power Over Ethernet (POE).

The second processor 520 may include at least one of the following:
A means 522 for receiving the improved sensor report 520 from each of at least two of the wireless sensor nodes 20 and 20-2 to create the table of the reading characteristics 156 for the wireless sensor node.
A means 524 for first generating the vehicle parameter 550 of the vehicle 6.
A means 526 for second generating the movement estimate 560 of the vehicle passing between the wireless sensor nodes 20 and 20-2.
A means 528 for third generating the traffic ticket message 570 based upon the movement estimate 560.
And a means 529 for sending at least one of the vehicle parameter 550, the movement estimate 560, and/or the traffic ticket message 570 to the traffic speed enforcement system 1000.

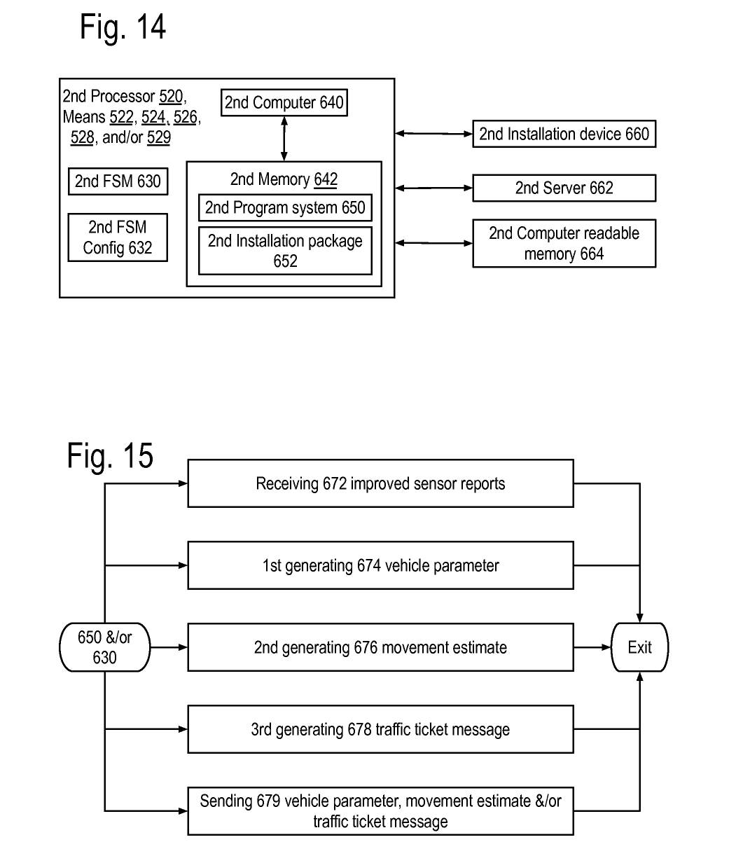

FIG. 14 shows at least one member of a means group that may include at least one implementation of at least one of a second finite state machine 630, a second computer 640 and a second accessible memory 642 including a second program system 650 configured to instruct the second computer 640. The means group consists of the second processor 520, the means 522 for receiving, the means 524 for first generating, the means 526 for second generating, the means 528 for third generating, and the means 529 for sending.

As before, the second FSM 630 may be configured to receive at least one input, maintain at least one state and generate at least one output in response to a value of at least one of the inputs and/or in response to the value of at least one of the states. The FSM configuration 632 may be used to configure the FSM 630 implemented by a programmable logic device, such as a Field Programmable Gate Array (FPGA).

The second computer 640 may include at least one instruction processor and at least one data processor with at least one of the instruction processor instructed by at least one of the instruction processors in response to the program system 650, possibly through accesses of the second memory 642 by the second computer 640.

The second installation package 652 may be configured to instruct the second computer 640 to install the second program system 650 and/or may be configured to instruct the second computer and/or the second FSM 630 to install the second FSM configuration 632.

As used herein, the second memory 642 and/or the second computer readable memory 664 may include at least one instance of a volatile and/or a non-volatile memory component. A volatile memory component tends to lose its memory contents without a regular supply of power, whereas a non-volatile memory component tends to retain its memory contents without needing such a regular supply of power.

The second computer readable memory 664 and/or the second server 662 and/or the second installation device 660 may include various communications interfaces to deliver the second program system 650, the second installation package 652, and/or the second FSM configuration 632: a Bluetooth interface, and/or a Wireless LAN (WLAN) interface, and/or some combination of these and possibly other interfaces.

FIG. 15 shows the second program system 650 includes, and/or the second FSM 630 is configured to support, at least part of at least one of the steps of
Receiving 672 the improved sensor report 530 from each of at least two of the wireless sensor nodes 20 and 20-2 to create the table of the reading characteristics 156.
First generating 674 the vehicle parameter 550 of the vehicle 6 in response to the table of the improved reading characteristics 156 for at least one of the wireless sensor nodes 20 and/or 20-2.
Second generating 676 the movement estimate 560 of the vehicle 6 passing near and/or between the wireless sensor nodes 20 and 20-2 in response to the tables of the improved reading characteristics 156.
Third generating 678 the traffic ticket message 570 based upon the movement estimate 560.
And sending 679 the vehicle parameter, the movement estimate and/or the traffic ticket message 570 to the traffic speed enforcement system 1000.

FIG. 16 shows a second set of embodiments as a third apparatus 800 including a third processor 820 that may be included in a third circuit board 472 and/or a third integrated circuit 474 and/or an access point 450 configured to communicate with wireless sensor nodes 8 and 8-2 that do not emulate increasing the sampling frequency of their sensors 12 and 12-2. The third apparatus 800 and/or the third processor 820 provide the wireless sensor network 2 an emulation of increased sampling frequency.
The third processor 820 may be configured to respond to sensor reports 23 and 23-2 received from at least two of the wireless sensor nodes 8 and 8-2 by creating at least one table of sensor reading estimates 24 for each of the wireless sensor nodes 8 and 8-2 emulating sensor readings 20 and 20-2 being generated by the wireless sensor nodes 12 and 12-2. The sensor readings are being generated N times per time unit, with the N being at least two.
The wireless sensor node 8 generates a sensor report 23 based upon the sensor readings 20 generated by the sensor 12. The wireless sensor node 8 wirelessly communicates 22 with the access point 450 to deliver the first sensor report 23 for use by the third processor 820. The third processor 820 responds to the first sensor report 23 by generating at least one first sensor reading estimate 24.
The second wireless sensor node 8-2 generates a second sensor report 23-2 based upon the second sensor readings 20-2 generated by the second sensor 12-2. The second wireless sensor node 8-2 wirelessly communicates 22 with the access point 450 to deliver the second sensor report 23-2 for use by the third processor 820. The third processor 820 responds to the second sensor report 23-2 by generating at least one second sensor reading estimate 24-2.
Please note, since the vehicle parameter 550 include the vehicle length estimate 552, in some embodiments of the third apparatus 800 may operate on just one sensor report 23 and just one sensor reading estimate 24. To simplify this discussion, only the sensor reading estimates 24 and not 24-2 will be discussed in what follows to simplify and clarify the disclosure. While this is being done to aid the clarity of the disclosure and expedite patent prosecution, it is not intended to limit the scope of the claims in any way.
Also, use of language such as the table of sensor reading estimates is meant to clarify the discussion and does not limit the implementation of the stored states of any of the apparatus 100, 500 and/or 800.
And the third processor 820 may respond to the table of the sensor reading estimates 24 to generate at least one improved estimate 150 and/or an improved time stamp 152 emulating the sensor readings 20 received at least twice the N times per time unit.

The sensor readings 20 and/or 20-2 may be distributed evenly or unevenly throughout the time unit as previously discussed in FIGS. 2A and 2B. The wireless sensor nodes 20 may be configured to use sensors 12 as previously discussed.

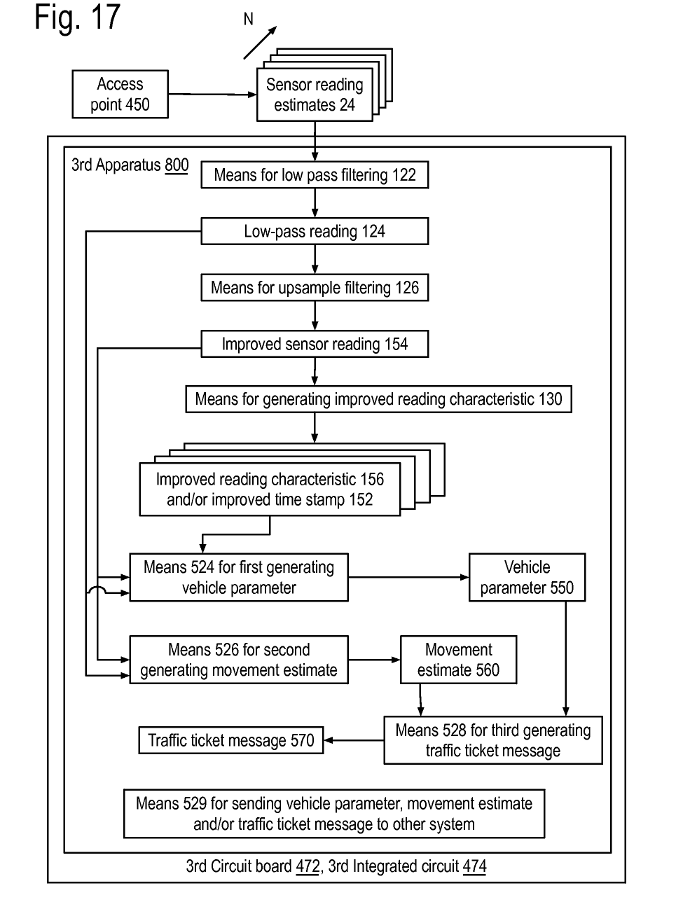

FIG. 17 shows another embodiment of the third apparatus 800 that is not included in the access point 450 but may be included in the third circuit board 472 and/or the third integrated circuit 474. Some details of the third processor 820 are shown indicating means for filtering sensor reading estimates 24, which are similar to the previous discussion of components with the same reference numbers.

In some embodiments a single integrated circuit may have configurations as the second integrated circuit 464 and as the third integrated circuit 474.

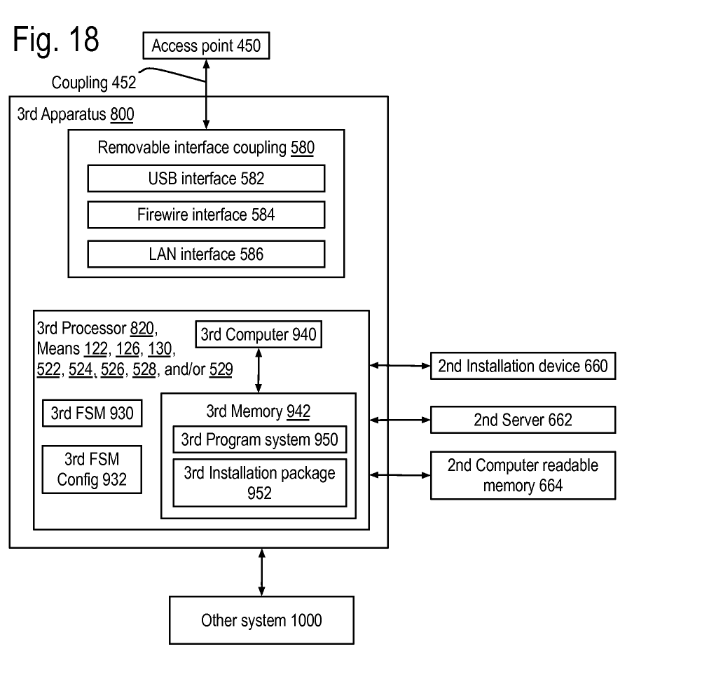

FIG. 18 shows the third apparatus 800 including a removable interface coupling 580 and the third processor 820 and/or at least one of its means including at least one instance of a third finite state machine 930 and/or a third computer 940 and/or a third accessible memory 942 possibly containing a third program system 950 and/or a third installation package 952. This set of embodiments may include the second installation device 660 and/or the second server 662 and/or a second computer readable memory 664 as previously discussed with regards the second apparatus 500.

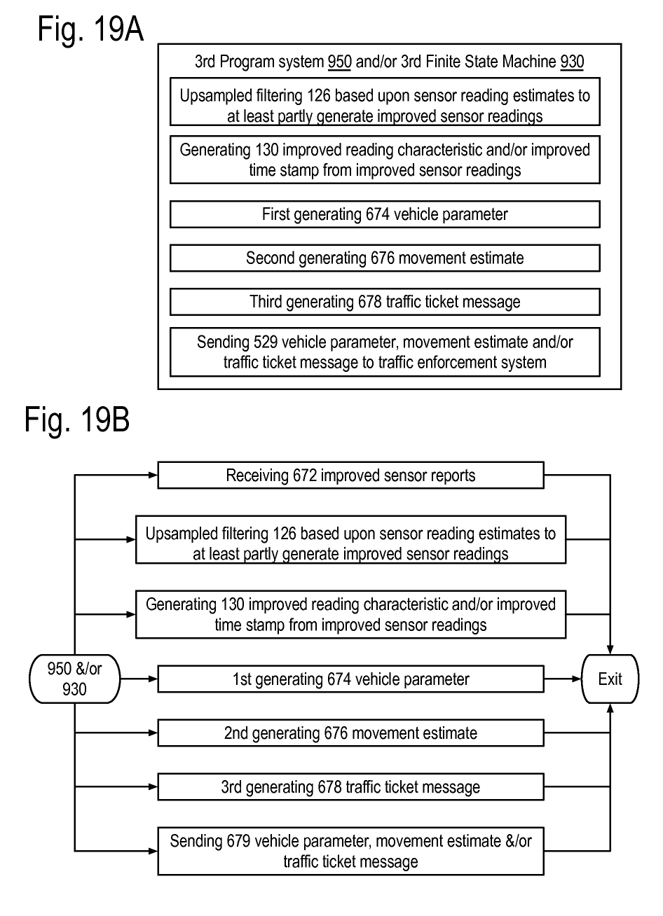

FIGS. 19A and 19B show some details of the third program system 950 and/or the operations of the third finite state machine 932 which are similar to a merger of the operations of the first processor 120 and second processor 520 with the main difference being that the third processor 820 starts with sensor reading estimates 24 and the first processor 120 starts with the sensor readings 20. Since like reference numbered components operate similarly to the previously discussed components with the same reference numbers, their discussion will not be repeated here.

The preceding discussion serves to provide examples of the embodiments and is not meant to constrain the scope of the following claims.

1. An apparatus for use in a wireless sensor node, comprising:
a processor configured to receive a sensor reading N times per time unit generated by a sensor and to generate at least one improved estimate and/or an improved time stamp emulating said sensor readings received at least twice said N times per time unit, wherein said N is at least two.

2. The wireless sensor node of claim 1, comprising:
said apparatus; and
a battery configured to provide electrical power to the apparatus.

3. An integrated circuit and/or a circuit board, comprising the apparatus of claim 1.

4. The apparatus of claim 1, wherein said sensor readings are distributed in one of evenly throughout said time unit and unevenly throughout said time unit.

5. The apparatus of claim 1, wherein said sensor includes at least one of a magnetic sensor, an electrostatic sensor, a humidity sensor, a proximity sensor, an accelerometer, a radar, a strain sensor, an optical sensor and a temperature sensor.

6. The apparatus of claim 5, wherein said magnetic sensor includes at least one of a magneto-resistive sensor, an inductive loop, and at least one instance of a Hall sensor;
wherein said optical sensor includes at least one of a Charge Coupled Device;
wherein said accelerometer includes at least one of a MEMS accelerometer and a piezoelectric accelerometer.

7. The apparatus of claim 1, wherein said improved estimate includes at least one of an improved sensor reading and an improved reading characteristic,
with said improved reading characteristic including at least one of an edge estimate, an extrema estimate, and/or a frequency domain estimate.

8. The apparatus of claim 7, wherein said processor is further configured to
upsample filter said sensor readings to generate said improved sensor reading and/or said improved time stamp and
generate said improved reading characteristic based upon said improved sensor reading.

9. The apparatus of claim 8, wherein said processor is further configured to low pass filter said sensor readings to generate low pass readings, and
said processor further generates said improved sensor reading based upon said upsample filter applied to said low pass readings.

10. The apparatus of claim 9, wherein said processor includes at least one of
means for generating said improved estimate and/or said improved time stamp emulating said sensor readings received at least twice said N times per time unit;
means for said low pass filter;
means for said upsample filter; and
means for generating said improved reading characteristic and/or said improved time stamp.

12. The apparatus of claim 10, wherein at least one member of a means group includes at least one instance of one of said finite state machine, said computer, an accessible memory containing a program system configured to instruct said computer;
wherein said means group consists of said processor, said means for generating said improved estimate and/or said improved time stamp, said means for said low pass filter, said means for said upsample filter, and said means for generating said improved reading characteristic.

13. The apparatus of claim 12, further includes at least one member of an installation group consisting of an installation device, a server and a computer readable memory, with said member including said program system and/or an installation package configured to instruct said computer to install said program system in said processor.

14. The apparatus of claim 12, wherein said program system includes and/or said finite state machine is configured to support at least part of at least one of the steps of:
generating said improved estimate with said improved time stamp emulating said sensor readings received at least twice said N times per time unit, further comprising at least one of the steps of
upsampling based upon said sensor readings to generate said improved sensor readings; and
low pass filtering said sensor readings to support generation of said improved sensor readings; and
generating said improved reading characteristic based upon said improved sensor readings, further comprising at least one of
generating said edge estimate;
generating said extrema estimate; and
generating said frequency domain estimate.

15. The apparatus of claim 1, wherein said processor is further configured to use at least one of a transmitter and/or a receiver,
with said transmitter used to transmit at least said improved estimate and/or said improved time stamp, and
with said receiver used to synchronize said wireless sensor node to said time unit.

16. The apparatus of claim 7, wherein said edge estimate indicates one of a rising edge, a falling edge, a leading edge and/or a trailing edge;
wherein said extrema estimate indicates one of a local minimum estimate and a local maximum estimate; and
wherein said frequency domain estimate includes at least one frequency band estimate.

17. The apparatus of claim 15,
wherein at least one of said transmitter and said receiver uses a carrier in at least one of an optical band, an infrared band and a radio band; and
wherein at least one of said transmitter and said receiver uses at least one of a Time Division Multiple Access (TDMA) scheme, a Frequency hopping scheme, a time hopping scheme, a code division multiple access (CDMA) scheme and an Orthogonal Frequency Division Modulation (OFDM) scheme.

18. The apparatus of claim 17, wherein at least one of said transmitter and said receiver are compatible with a version of at least one of an Institute for Electrical and Electronic Engineers (IEEE) 802[period]15[period]4 protocol, an IEEE 802[period]11 protocol, a Bluetooth protocol and a Bluetooth low power protocol.

19. A second apparatus for said wireless sensor nodes implementing the apparatus of claim 7, including
said second apparatus configured to receive said improved sensor report from each of at least two of said wireless sensor nodes to create said reading characteristics for said wireless sensor node in response to said presence of a vehicle near said wireless sensor node, and
a second processor configured to generate at least one of a vehicle parameter of said vehicle, a movement estimate of said vehicle passing between said wireless sensor nodes, and a traffic ticket message.

20. The second apparatus of claim 19, wherein said movement estimate of said vehicle includes at least one of a velocity estimate and an acceleration estimate; and
wherein said vehicle parameter includes at least one of a vehicle length, a number of axles, and at least one axle position.

21. The second apparatus of claim 20, wherein said movement estimate is based upon at least one of
a first correlation of said extrema estimates from said wireless sensor nodes to create a correlated extrema and
a second correlation of said edge estimates from said wireless sensor nodes to create a correlated edges.

22. The second apparatus of claim 21, wherein said second processor is further configured to perform at least one of
generate a confidence estimate for said movement estimate, and
generate said movement estimate further based upon a difference of said time stamps of said correlated extrema and/or said correlated edges.

23. The second apparatus of claim 19, further comprising said second processor configured to communicate with an access point to receive said improved sensor reports.

24. The second apparatus of claim 23, further comprising a removable interface coupled to said second processor, with said second processor configured to use said removable interface to receive said improved sensor report.

25. The second apparatus of claim 19, wherein said second processor comprises at least one of
means for receiving said improved sensor report from each of at least two of said wireless sensor nodes to create said table of said improved reading characteristics for said wireless sensor node;
means for first generating said vehicle parameter of said vehicle;
means for second generating said movement estimate of said vehicle passing between said wireless sensor nodes;
means for third generating said traffic ticket message; and
means for sending at least one of said movement estimate and said traffic ticket message to said other system.

26. The second apparatus of claim 25, wherein at least one member of a means group includes at least one implementation of at least one of a second finite state machine, a second computer and a second accessible memory including a second program system configured to instruct said second computer,
with said means group consisting of said members: said second processor, said means for receiving, said means for first generating, said means for second generating, said means for third generating, and said means for sending.

27. The second apparatus of claim 26,
wherein said second program system includes, and/or said second finite state machine is configured to support, at least part of at least one of said steps of:
receiving said improved sensor report from each of at least two of said wireless sensor nodes to create said table of said improved reading characteristics for said wireless sensor node;
first generating said vehicle parameter of said vehicle;
second generating said movement estimate of said vehicle;
third generating said traffic ticket message based upon said movement estimate and/or said vehicle parameter; and
sending at least one of said vehicle parameter, said movement estimate, and/or said traffic ticket message to a traffic speed enforcement system.

28. A second circuit board and/or a second integrated circuit including said second processor of claim 19.

29. An access point configured to wirelessly communicate with said wireless sensor nodes of claim 19, comprising: said second processor.

30. An apparatus (800), comprising:
a processor (820) configured to
respond to sensor reports received from at least two wireless sensor nodes by creating at least one table of sensor estimates for each of said wireless sensor nodes emulating sensor readings being generated by said wireless sensor node N times per time unit, with said N is at least two, and
respond to said table of said sensor reading estimates to generate at least one improved estimate and/or an improved time stamp emulating said sensor readings received at least twice said N times per time unit.

31. The apparatus of claim 30, wherein said sensor readings are distributed in one of evenly throughout said time unit and unevenly throughout said time unit.

32. The apparatus of claim 30, wherein at least one of said wireless sensor nodes is configured to generate said sensor reading from at least one sensor of a magnetic sensor, an electrostatic sensor, a humidity sensor, a proximity sensor, an accelerometer, a radar, a strain sensor, an optical sensor and a temperature sensor;
wherein said magnetic sensor includes at least one of a magneto-resistive sensor, an inductive loop, and at least one instance of a Hall sensor;
wherein said optical sensor includes at least one of a Charge Coupled Device; and
wherein said accelerometer includes at least one of a MEMS accelerometer and a piezoelectric accelerometer.

33. The apparatus of claim 30, wherein said improved estimate includes at least one of an improved sensor reading and an improved reading characteristic,
with said reading characteristic including at least one of an edge estimate, an extrema estimate, a frequency domain estimate.

34. The apparatus of claim 33, wherein said processor is configured to upsample filter said sensor readings to create said improved sensor reading, and
said processor is further configured to generate said improved reading characteristic based upon said improved sensor reading.

35. The apparatus of claim 34, wherein said processor is further configured to low pass filter said sensor estimates to generate low pass filter readings further used to generate said improved reading characteristic.

36. The apparatus of claim 33, wherein said edge estimate includes at least one of a rising edge, a falling edge, a leading edge and/or a trailing edge;
wherein said extrema estimate includes at least one of a local minimum estimate and a local maximum estimate; and
wherein said frequency domain estimate includes at least one frequency band estimate.

37. The apparatus of claim 33, wherein said processor is further configured to generate at least one of a vehicle parameter of said vehicle, a movement estimate of said vehicle passing between said wireless sensor nodes, and a traffic ticket message;
wherein said movement estimate of said vehicle includes at least one of a velocity estimate and an acceleration estimate; and
wherein said vehicle parameter includes at least one of a vehicle length, a number of axles, and at least one axle position.

38. The apparatus of claim 37, wherein said movement estimate is based upon at least one of
a first correlation of said extrema estimates from said wireless sensor nodes to create a correlated extrema and
a second correlation of said edge estimates from said wireless sensor nodes to create a correlated edges.

39. The apparatus of claim 38, wherein said processor is further configured to perform at least one of
generate a confidence estimate for said movement estimate, and
generate said movement estimate further based upon a difference of said time stamps of said correlated extrema and/or said correlated edges.

40. The apparatus of claim 37, further comprising said processor configured to communicate with an access point to receive said sensor reports.

41. The apparatus of claim 40, further comprising a removable interface coupled to said processor, with said processor configured to use said removable interface to receive said sensor report.

42. The apparatus of claim 37, wherein said processor comprises at least one of
means for responding to said sensor reports received to create said table of sensor estimates;
means for responding to said table of said sensor estimates to generate said improved estimate and/or said improved time stamp;
means for first generating said vehicle parameter of said vehicle;
means for second generating said movement estimate of said vehicle passing between said wireless sensor nodes;
means for third generating said traffic ticket message; and
means for sending at least one of said movement estimate and said traffic ticket message to an other system.

43. The apparatus of claim 42, wherein at least one member of a means group includes at least one implementation of at least one of a finite state machine, a computer and an accessible memory including a program system configured to instruct said computer;
wherein said means group consists of said members of
said processor,
said means for responding to said sensor reports,
said means for responding to said table of said sensor readings,
means for first generating said vehicle parameter of said vehicle;
means for second generating said movement estimate of said vehicle passing between said wireless sensor nodes;
means for third generating said traffic ticket message; and
means for sending at least one of said movement estimate and said traffic ticket message to said other system.

44. The apparatus of claim 43, wherein said program system includes, and/or said finite state machine configured to support, at least part of at least one of said steps of:
responding to said sensor reports received to create at least one table of sensor readings for each of said wireless sensor nodes emulating said sensor readings being generated by said wireless sensor node N times per time unit,
responding to said table of said sensor reading estimates to generate at least one improved estimate with an improved time stamp emulating said sensor readings received at least twice said N times per time unit,
first generating said vehicle parameter of said vehicle;
second generating said movement estimate of said vehicle;
third generating said traffic ticket message based upon said movement estimate and/or said vehicle parameter; and
sending at least one of said vehicle parameter, said movement estimate, and/or said traffic ticket message to a traffic speed enforcement system.

45. A circuit board and/or an integrated circuit including said processor of claim 30.

46. An access point configured to wirelessly communicate with said wireless sensor nodes of claim 30, comprising: said processor.
